(19) United States
(12) Patent Application Publication
(10) Pub. No.: US 2003/0020390 A1
(43) Pub. Date: Jan. 30, 2003

(54) Flat cathode-ray tube, electron gun for flat cathode-ray tube and producing method thereof

(76) Inventors: Jun Miura, Fukishima (JP); Koichi Furui, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/893,000

(22) Filed: Jun. 28, 2001

(30) Foreign Application Priority Data
Apr. 3, 2001 (JP) P2001-105082

(51) Int. Cl. H01J 29/46

(52) U.S. Cl. 313/442; 313/440

(57) ABSTRACT

In a flat cathode-ray tube, there are problems that an axis of electron beam is separated before the electron beam enters a main lens due to magnetic field of a magnet disposed outside a neck, and coma aberration is generated to degrade an image quality. It is an object of the present invention to solve these problems. A flat cathode-ray tube comprises an electron gun 281 having a main lens 35M whose center coincides with a tube axis, a deflection yoke, and a magnet disposed outside a neck. An axis of a prefocus lens of the electron gun is separated from the tube axis.

### BACKGROUND OF THE INVENTION

1. Field of the Invention

The present invention relates to a flat cathode-ray tube, an electron gun used for the flat cathode-ray tube and a producing method of the gun.

2. Description of the Related Art

Conventionally, in the case of a flat cathode-ray tube, since the depth dimension thereof in a direction for watching a screen panel can be reduced, the flat cathode-ray tubes are preferably used for a portable television set, an in-car television set, a door phone and the like which require thin image receivers for example.

A conventional flat cathode-ray tube is shown in FIG. 1 and FIG. 2.

A flat cathode-ray tube 1 includes a glass tube body 7 comprising a front panel 2, a screen panel 4 formed with a fluorescent surface 3 and a funnel 6 having a neck 5 which are frit-jointed to one another. An electron gun 8 is disposed in the neck 5 of the funnel 6 such that a center axis of the electron gun 8 coincides with a tube axis 11 of the neck 5. A deflection yoke 14 having a horizontal deflection coil 12 and a vertical deflection coil 13 is provided outside from the neck 5 of the glass tube body 7 to the funnel 6. A magnet, a so-called centering magnet 9 for adjusting electron beam such that the electron beam scans an effective screen, i.e., a fluorescent surface is disposed at a position closer to a front portion of the deflection yoke 14. The centering magnet 9 comprises two ring-like double-pole magnets (permanent magnets) 9a and 9b.

In the case of the deflection yoke 14, in view of costs and deflection sensibility, a saddle type coil is generally used as the horizontal deflection coil 12 and a toroidal type coil is generally used as the vertical deflection coil 13. An electron beam 15 emitted from an electron gun 13 is deflected in the vertical direction and radiates onto the fluorescent surface 3 of the screen panel 4. The electron beam 15 is deflected symmetrically with respect to the deflection center in the horizontal direction, but is deflected asymmetrically in the vertical direction.

The glass tube body 7 is formed to a flat shape such that the glass tube body 7 becomes longer in the lateral direction in a horizontally defecting direction. The screen panel 4 is disposed in an inclining manner such that the screen panel 4 crosses the tube axis 11 diagonally. An image formed on the screen panel 4 can be seen from the front panel 2. The front panel 2 is transparent and formed in a flat plate-like shape. The flat cathode-ray tube in this case is a reflective type tube. On the contrary, when the image on the screen panel 4 is seen from the side of the screen panel 4, the flat cathode-ray tube is a transparent type tube.

As shown in FIG. 4, the conventional flat cathode-ray tube 1 causes coma aberration which leaves a trail of light behind a luminescent spot on the screen panel 4 like Mercury. A beam spot 17 is visually seen with halation, and image quality is degraded.

The present inventors researched a cause of degradation of this beam spot and as a result, and they found that a magnetic field due to the centering magnet 9 on the side of the neck influences the beam spot. That is, by the effect of the magnetic field from the centering magnet 9, as shown in FIG. 3, the electron beam 15 is deflected before the beam 15 enters a main lens 16M, and the electron beam 15 is separated from the tube axis 11, i.e., a so-called “axis-separation” is generated. Since the axis-separation is generated on the side of a cathode K of the main lens 16M, the electron beam 15 radiates onto a position deviated from a center O of the main lens 16M. Therefore, the coma aberration is generated, the beam spot 17 attended with halation is generated, which degrades the image quality.

### SUMMARY OF THE INVENTION

In view of the above circumstances, the present invention provides a flat cathode-ray tube, an electron gun used for the flat cathode-ray tube and a producing method of the gun capable of reducing the degradation of a beam spot caused by effect of a magnet.

A flat cathode-ray tube according to the present invention includes a magnet outside of a neck, and a prefocus lens of an electron gun is separated from the tube axis.

According to the flat cathode-ray tube, since an axis of the prefocus lens is separated in an opposite direction in correspondence with an axis-separating amount of the electron beam whose axis is separated by effect of the magnet outside the neck, the electron beam passing through the focus lens is moved in a direction opposite to the axis-separating direction caused by the magnet, the axis-separation and the axis-separating amount are offset by each other, and the electron beam passes through a center of the main lens.

An electron gun for a flat cathode-ray tube of the present invention comprises a cathode and a plurality of grids, characterized in that a prefocus lens is separated from a center axis of an electron gun in a direction in which an axis-separating amount of an electron beam caused by a magnetic field of a magnet which is disposed outside of a neck becomes smaller.

According to the electron gun for a flat cathode-ray tube of the invention, the prefocus lens is separated from the center axis of an electron gun in a direction in which the axis-separating amount of the electron beam caused by the magnetic field of the magnet which is disposed outside of the neck becomes smaller. Therefore, when the gun is used for the flat cathode-ray tube, the electron beam passing through the focus lens is moved in a direction opposite to the axis-separating direction caused by the magnetic field of the magnet, the axis-separation and the axis-separating amount are offset by each other, and the electron beam passes through a center of the main lens.

A producing method of an electron gun for a flat cathode-ray tube according to the present invention comprises the steps of: preparing a first grid having an electron beam through hole formed at a reference position and having a positioning hole formed at another reference position, and preparing a second grip having an electron beam through hole separated from a reference position by a predetermined distance and having a positioning hole formed at another reference position, and inserting positioning means in the positioning holes of the first and second grids for positioning the first and second grids in a state that a spacer is interposed between the first and second grids.

According to the producing method of the electron gun for the flat cathode-ray tube of the invention, the electron beam through hole of the second grid is previously separated from the reference position by a predetermined distance, and the first and second grids are positioned by the positioning means through the spacer therebetween. Therefore, it is possible to easily and precisely produce an electron gun which is formed such that the prefocus lens can correct the axis-separation of the electron gun.

Another producing method of an electron gun for a flat cathode-ray tube of the invention comprises the steps of: preparing a first grid having an electron beam through hole formed at a reference position and having a positioning hole formed at another reference position, and preparing a second grip having an electron beam through hole formed at a reference position and having a positioning hole formed at another reference position, and inserting positioning means in the positioning holes of the first and second grids for positioning the first and second grids such that an end surface having an electron beam through hole of the second grid is inclined with respect to the first grid in a state that a tapered spacer is interposed between the first and second grids.

According to the producing method of the electron gun for the flat cathode-ray tube of the invention, the first and second grids are positioned by the positioning means through the tapered spacer therebetween. Therefore, it is possible to easily and precisely produce an electron gun which is formed such that the prefocus lens can correct the axis-separation of the electron gun.

### BRIEF DESCRIPTION OF THE DRAWINGS

FIG. 1 shows a structure of a conventional flat cathode-ray tube;

FIG. 2 is a partially sectional plan view of the conventional flat cathode-ray tube;

FIG. 3 is an enlarged view showing an electron gun of the conventional flat cathode-ray tube;

FIG. 4 is a plan view of the conventional flat cathode-ray tube in which beam spots causing halation are shown;

FIG. 5 shows a structure of one mode of a flat cathode-ray tube of the present invention;

FIG. 6 is a perspective view showing an example of a centering magnet mounted to the flat cathode-ray tube;

FIG. 7 shows a structure of one mode of an electron gun for the flat cathode-ray tube of the invention;

FIG. 8 is an explanatory view showing effect of a prefocus lens in the electron gun of the invention;

FIG. 9 shows a structure showing another mode of the electron gun for the flat cathode-ray tube of the invention;

FIG. 10 shows a structure showing another mode of the electron gun for the flat cathode-ray tube of the invention;

FIG. 11 shows a structure of another mode of the flat cathode-ray tube of the invention;

FIG. 12 show steps for explaining one mode of a producing method of the electron gun for the flat cathode-ray tube of the invention, wherein

FIG. 12A is a perspective view of a first grid and

FIG. 12B is a perspective view of a second grid;

FIG. 13 shows a step (2) for explaining one mode of the producing method of the electron gun for the flat cathode-ray tube of the invention;

FIG. 14 is a perspective view showing an example of a spacer used in FIG. 13;

FIG. 15 shows a step (3) for explaining one mode of the producing method of the electron gun for the flat cathode-ray tube of the invention;

FIG. 16 show a step (3) for explaining another mode of the producing method of the electron gun for the flat cathode-ray tube of the invention, wherein

FIG. 16A is a perspective view of a first grid and

FIG. 16B is a perspective view of a second grid;

FIG. 17 shows a step (2) for explaining another mode of the producing method of the electron gun for the flat cathode-ray tube of the invention;

FIG. 18 is a perspective view showing an example of the spacer used in FIG. 17;

FIG. 19 shows a step (3) for explaining another mode of the producing method of the electron gun for the flat cathode-ray tube of the invention;

FIG. 20 is a graph showing a relation between a distance Z in an axial direction of the tube and an axis-separating amount of the electron beam using the axis-separating amount of the electron beam through hole h_{G2} of the second grid G₂ as a parameter;

FIG. 21 is a graph showing a relation between an SP moving amount and the axis-separating amount of the electron beam through hole h_{G2} of the second grid G₂ using a simulation result and actually measured data;

FIG. 22 is a plan view of the flat cathode-ray tube of the invention in which beam spots having no halation are shown;

FIG. 23 is a graph showing a relation between a halation width and the axis-separating amount of the electron beam through hole h_{G2} of the second grid G₂;

FIG. 24 is a graph showing a relation between the SP moving amount and the halation width using the axis-separating amount of the electron beam through hole h_{G2} of the second grid G₂ as a parameter; and

FIG. 25 is a graph showing one example of a correlation between the magnetic field of the centering magnet and a positional deviation amount of the electron beam spot on the fluorescent surface.

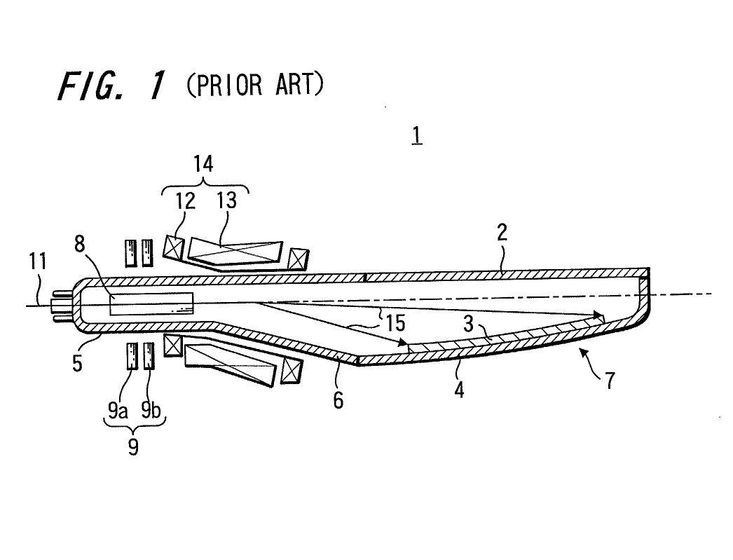

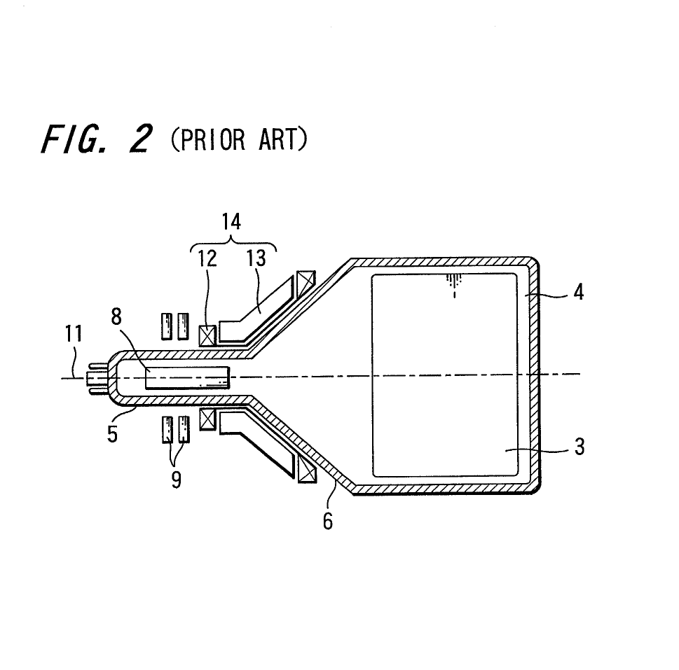

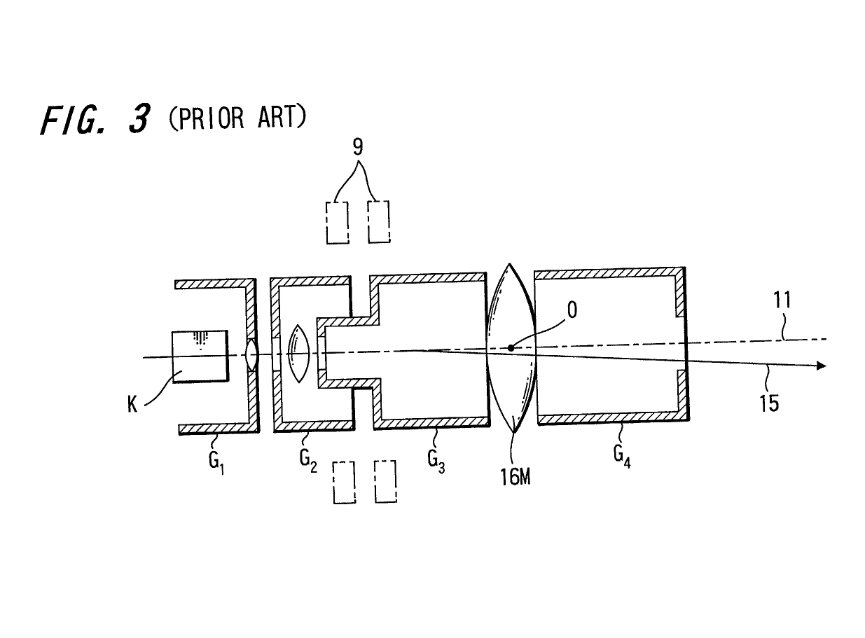

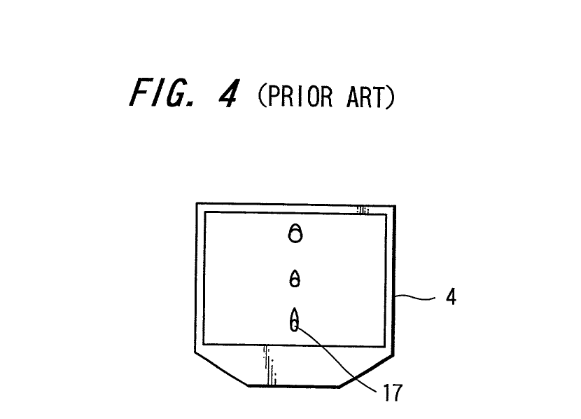

### DETAILED DESCRIPTION OF THE PREFERRED EMBODIMENTS

Modes of a flat cathode-ray tube according to the present invention will be explained below.

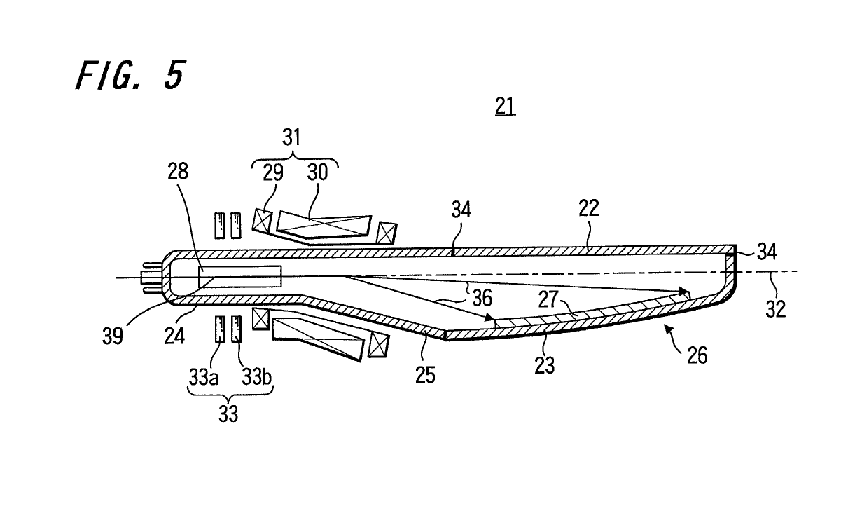

FIG. 5 shows one mode of the flat cathode-ray tube of the invention.

The flat cathode-ray tube 21 of this mode includes a glass body 26 comprising a front panel 22, a screen panel 23 and a funnel 25 having a neck 24. These members constituting the glass body 26 are jointed to one another through frit glasses. A fluorescent surface 27 is formed on an inner surface of the screen panel 23. An electron gun 28 of the present invention which will be described latter is disposed in the neck 24 of the funnel 25 such that a center axis 39 coincides with a tube axis 32. Reference number 34 represents a frit joint portion. The glass body 26 is formed flatly such that the glass body 26 is laterally longer in the horizontal direction (vertical direction with respect to a paper sheet of FIG. 5) as a whole. The front panel 22 is formed into a transparent flat plate-like shape at a position opposed to the screen panel 23. The screen panel 23 is disposed diagonally or in parallel to a direction crossing the tube axis 32 diagonally. In FIG. 5, the screen panel 23 is disposed diagonally with respect to the tube axis 32.

A deflection yoke 31 having a horizontal deflection coil 29 and a vertical deflection coil 30 is disposed outside of the glass body 26 at a location thereof from the neck 24 to the funnel 25. A saddle type coil is used as the horizontal deflection coil 29 and a toroidal type coil is used as the vertical deflection coil 30. A combination of any of the saddle type coil and the toroidal type coil may be used.

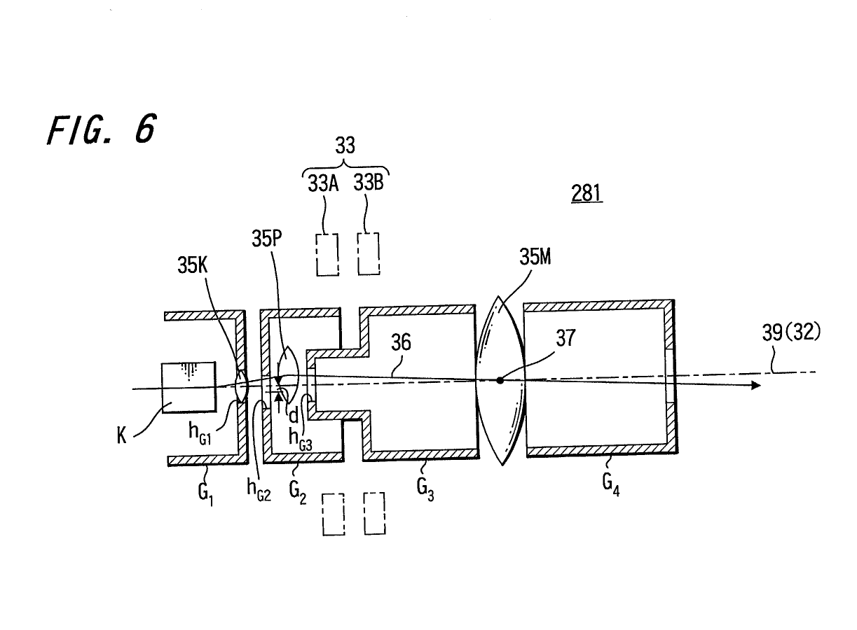

A centering magnet 33 for adjusting electron beam such that the electron beam scans an effective screen, i.e., a fluorescent surface 27 is disposed at an outer side of the neck 24 corresponding to a front portion of the deflection yoke 31. As shown in FIG. 6, the centering magnet 33 comprises two ring-like double-pole magnets (permanent magnets) 33a and 33b.

In this flat cathode-ray tube 21, a centering adjustment is carried out such that the screen comes to a proper position, i.e., to the fluorescent surface by means of the centering magnet 33. An electron beam 36 emitted from the electron gun 28 is deflected in the horizontal and vertical directions by the deflection yoke 31 and radiates onto the fluorescent surface 27 of the screen panel 23. The electron beam 36 is deflected symmetrically with respect to the deflection center in the horizontal direction, but is deflected asymmetrically in the vertical direction. A screen formed on the screen panel 23 can be seen from the side of the front panel 22 as described above. The flat cathode-ray tube in this case is a reflective type tube. In this flat cathode-ray tube 21, when the image on the screen panel 23 is seen from the side of the screen panel 23, the flat cathode-ray tube is a transparent type tube.

[First Example of Electron Gun]

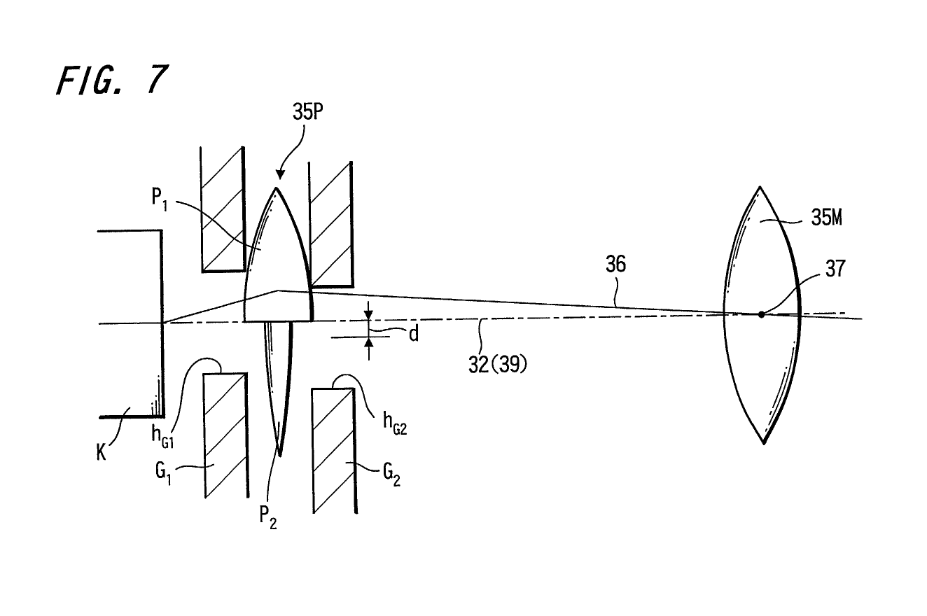

FIG. 7 shows a mode of the electron gun 28 according to the present invention.

An electron gun 281 of this mode comprises a first grid G₁, a second grid G₂, a third grid G₃ and a fourth grid G₄. These grids G₁ to G₄ are arranged in this order along a direction of the tube axis 32. A cathode lens 35K is formed between a cathode K, the first grid G₁ and the second grid G₂. A prefocus lens 35P is formed between the second grid G₂ and the third grid G₃. A main lens 35M is formed between the third grid G₃ and the fourth grid G₄. In this example, the electron gun is formed as a so-called bipotential type electron gun.

In the flat cathode-ray tube using the centering magnet 33, the axis-separation is generated in the electron beam before the electron beam enters the main lens by the magnetic field of the centering magnet 33, and the coma aberration is generated. This coma aberration is proportional to an axis-separating amount of the electron beam before the electron beam enters the main lens.

In this mode, especially in order to separate the prefocus lens 35P from the tube axis 32, the second grid G₂ is separated from the tube axis 32 in one direction. In this mode, although the second grid G₂ is disposed coaxially with respect to the first grid G₁ and the third grid G₃, a center of a hole of an electron beam through hole h_{G2} is separated from the tube axis 32 by a predetermined amount (distance), and this arrangement is called “axis-separation”. An electron beam through hole h_{G1} of the first grid G₁ and an electron beam through hole h_{G3} of the third grid G₃ are formed such that centers of these holes exist on the tube axis 32. The electron beam through holes h_{G1}, h_{G2} and h_{G3} of the first to third grids G₁, G₂ and G₃ are formed are formed circularly in this mode.

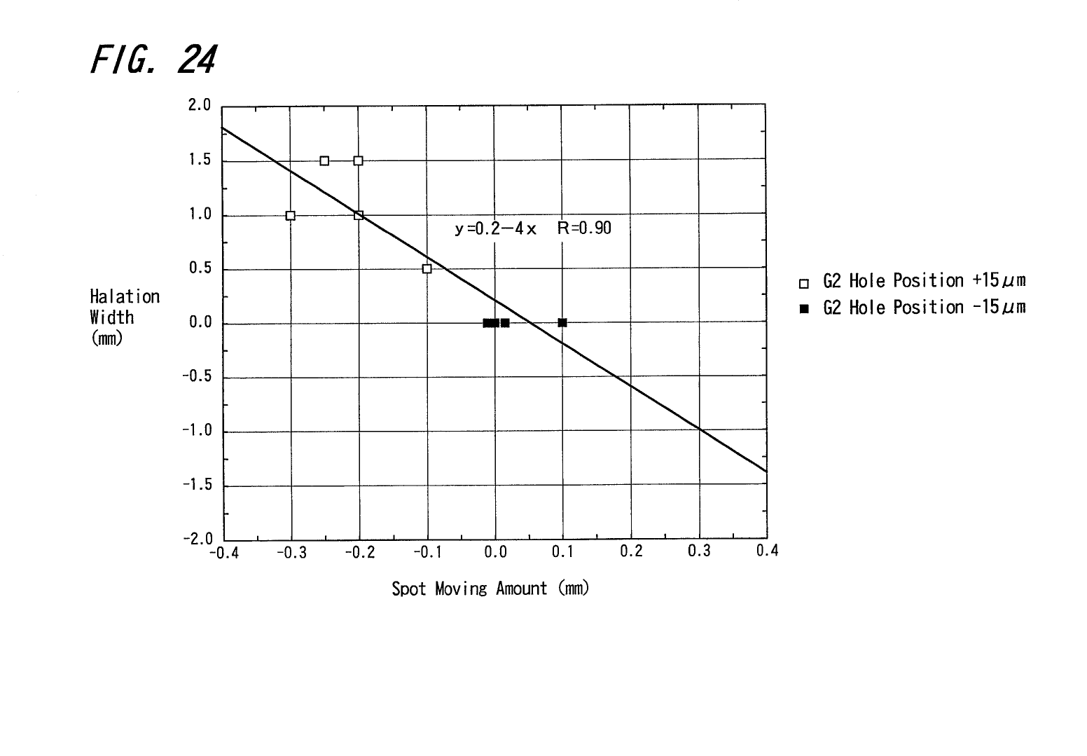

A direction to separate the second grid G₂ is set to a direction in which the axis-separating amount of the electron beam becomes small. That is, as shown in FIG. 24, the electron beam before the beam enters the main lens is separated downward from the tube axis. Therefore, in the electron gun 281 of this mode, the second grid G₂, i.e., its electron beam through hole h_{G2} is previously separated (deviated) in the same direction as the axis-separation direction (in a minus direction when the axis-separation direction of the electron beam is set in the minus direction) by a predetermined distance d which corresponds to an amount in which the axis-separating amount of the electron beam can be corrected.

Centers of the cathode lens 35K and the main lens 35M coincide with the center axis 39, and the prefocus lens 35P is separated from the center axis 39 by a predetermined distance.

Next, a working effect and an effect of the flat cathode-ray tube 21 having this electron gun 281 will be explained.

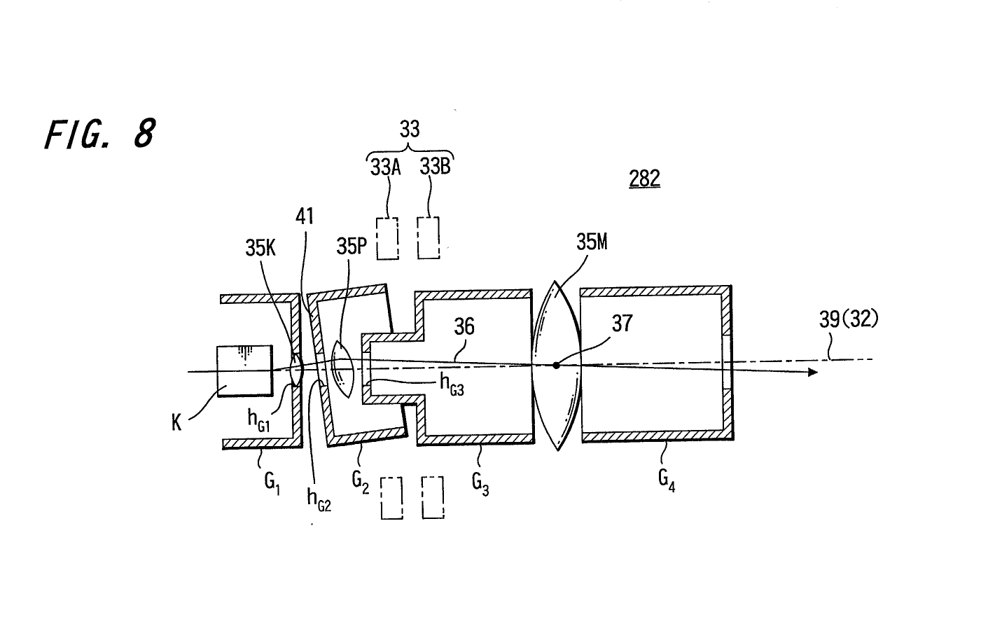

In the flat cathode-ray tube 21 of this mode, the axis of the electron beam through hole h_{G2} of the second grid G₂ which contributes to the formation of the prefocus lens 35P is separated in the same direction as the axis-separation direction by a distance corresponding to the axis-separating amount of the electron beam. Therefore, as shown in FIG. 8, a lens effect of an upper side P1 of the prefocus lens 35P is strong, and the lens effect of a lower side P2 of the prefocus lens 35P is weak. To appearance, the axis prefocus lens 35P is separated. That is, since the electron beam through hole h_{G2} of the second grid G₂ is deviated, an upper edge of the electron beam through hole h_{G2} approaches the tube axis 32 to strengthen the upper magnetic field strength, and a lower edge of the electron beam through hole h_{G2} is separated from the tube axis 32 to weaken the lower magnetic field strength. As a result, the lens effect of the upper side P1 is strong, and the lens effect of the lower side P2 is weak. For this reason, the electron beam 36 passing through the prefocus lens 35P moves (i.e., is bent) in upward direction in which the magnetic field is strong and the electron beam 36 is refracted so as to return, and passes through the center 37 of the main lens 35M. With this design, it is possible to eliminate the halation caused by the coma aberration, and to enhance the resolution.

On the other hand, the electron beam 36 straightly running at the time of non-deflection radiates onto a screen inoperative portion except a frit junction portion 34 of the glass body 26. Therefore, the frit junction portion 34 is not deteriorated, the durability thereof becomes excellent, and the reliability of the flat cathode-ray tube is enhanced.

[Second Example of Electron Gun]

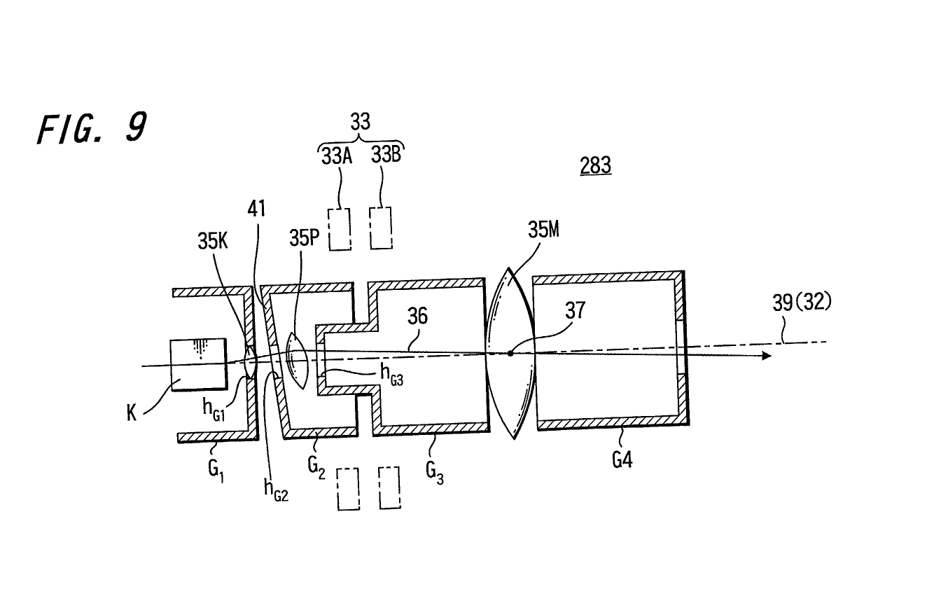

FIG. 9 shows another mode of the electron gun 28 according to the present invention.

An electron gun 282 of this mode comprises a first grid G₁, a second grid G₂, a third grid G₃ and a fourth grid G₄. These grids G_{1 to G}₄ are arranged in this order along a direction of the tube axis 32. A cathode lens 35K is formed between a cathode K, the first grid G₁ and the second grid G₂. A prefocus lens 35P is formed between the second grid G₂ and the third grid G₃. A main lens 35M is formed between the third grid G₃ and the fourth grid G₄. In this example, the electron gun is formed as a so-called bipotential type electron gun.

In this mode, although the second grid G₂ which contributes to the formation of the prefocus lens 35P is disposed coaxially with respect to the first grid G₁ and the third grid G₃, an end surface 41 having the electron beam through hole h_{G2} is disposed such that the end surface 41 is inclined with respect to the tube axis 32, so that the lens effect, therefore the magnetic field strength of the prefocus lens 35P is different between the upper side and the lower side of the lens 35P. The axis of the prefocus lens 35P is separated from the tube axis 32. FIG. 9 schematically shows that the prefocus lens 35P is inclined with respect to the tube axis 32. The electron beam through holes h_{G1}, h_{G2} and h_{G3} of the first to third grids G₁, G₂ and G₃ are formed are formed circularly in this mode. Therefore, the electron beam through hole h_{G2} of the second grid G₂ is not a point in shape as viewed from the center axis 39 (an oval figure in this mode).

In this mode, the second grid G₂ is inclined such the upper end of the second grid G₂ approaches the first grid G₁ as shown in FIG. 9.

The end surface 41 having the electron beam through hole h_{G2} of the second grid G₂ is inclined through a predetermined angle. Therefore, in the prefocus lens 35P, the upper side lens effect in FIG. 9 is strong and the lower side lens effect is weak. The electron beam 36 passing through the prefocus lens 35P moves upward above the tube axis 32 in FIG. 9, so that the electron beam 36 passes through the center of the main lens 35M. With this design, it is possible to eliminate the halation caused by the coma aberration, and to enhance the resolution.

Like the flat cathode-ray tube using the above-described electron gun 281, the electron beam 36 straightly running at the time of deflection radiates onto a screen inoperative portion except a frit junction portion 34 of the glass body 26. Therefore, the frit junction portion 34 is not deteriorated.

[Third Example of Electron Gun]

In the above example, the second grid G₂ itself is inclined. Alternatively, an electron gun 283 may be formed such that only the end surface 41 having the electron beam through hole h_{G2} is inclined without inclining the second grid G₂ itself. The electron beam through hole h_{G2} in this case is circular in shape on the end surface 41 and thus, the electron beam through hole h_{G2} is an oval figure in shape as viewed from the tube axis in its inclined state. In this electron gun 283 having this structure also, the same working effect and effect as those shown in FIG. 9 can be obtained.

Next, a producing method of the electron gun according to the previous mode.

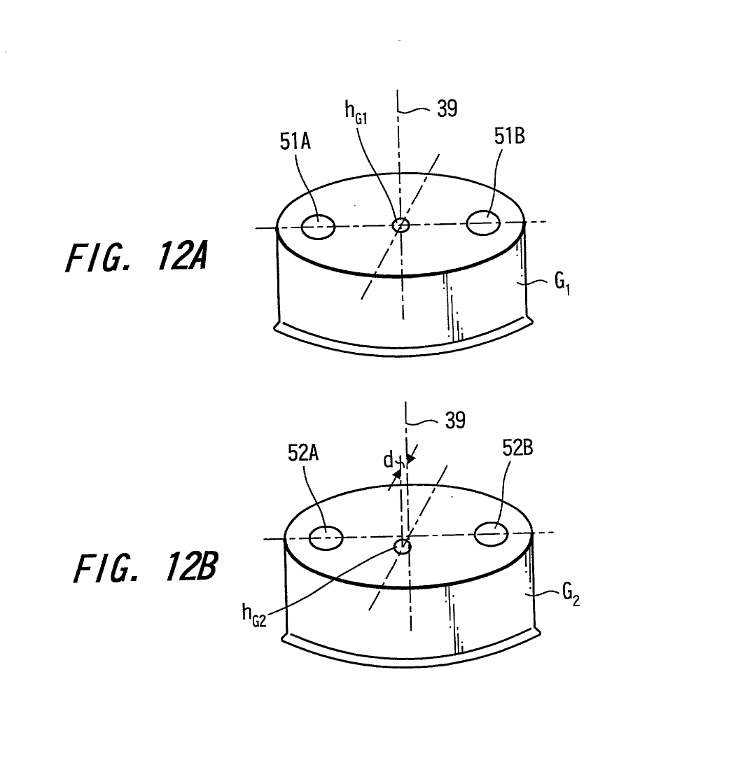

FIGS. 12 to 15 show a mode of the producing method of the above-described electron gun 281. In this mode, as shown in FIGS. 12, the first grid G₁ (FIG. 12A) and the second grid G₂ (FIG. 12B) are prepared first. In the first grid G₁, its electron beam through hole h_{G1} having a hole center which coincides with one reference position corresponding to a position on the center axis 39, and the first grid G₁ is formed with a pair of so-called index holes 51 (51A, 51B) at symmetrical positions about the electron beam through hole h_{G1}. The index holes 51 are used for positioning at the time of assembling. The second grid G₂ is formed with the electron beam through hole h_{G2} having a hole center at a position separated from the center axis 39 by a predetermined distance d. The second grid G₂ is also formed with a pair of index holes 52 (52A, 52B) at other reference positions like the first grid G₁.

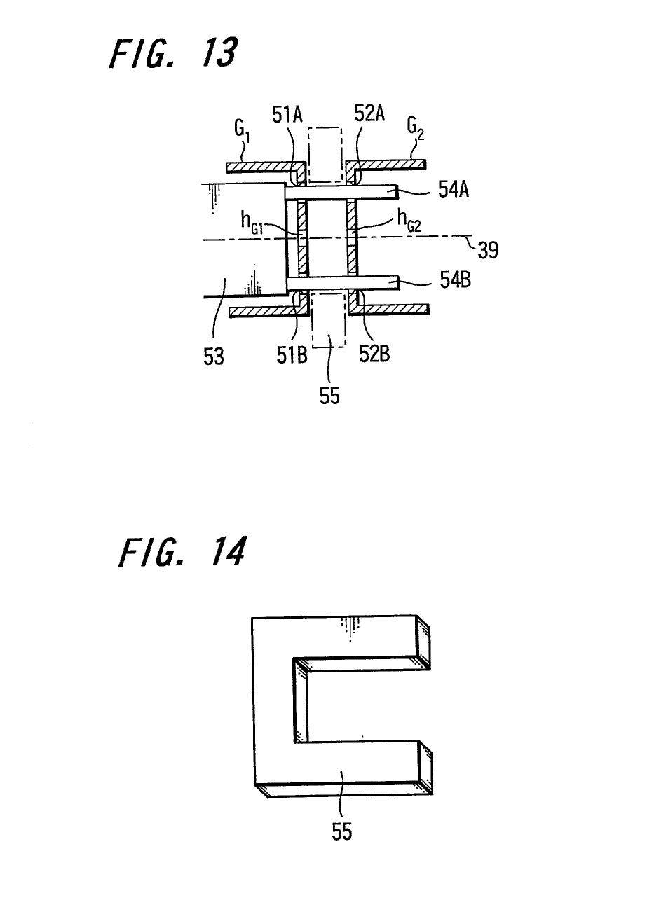

Next, as shown in FIG. 13, the first grid G₁ is positioned by inserting positioning means, e.g., a pair of index pins 54 (54A, 54B) embedded in a pad 53 into index holes 51 (51A, 51B) of the first grid G₁. Then, the second grid G₂ is positioned on the first grid G₁ by inserting index pins 54 (54A, 54B) into the index holes 52 (52A, 52B) through a U-shaped spacer 55 (see FIG. 14) which defines a distance between first grid G₁ and the second grid G₂.

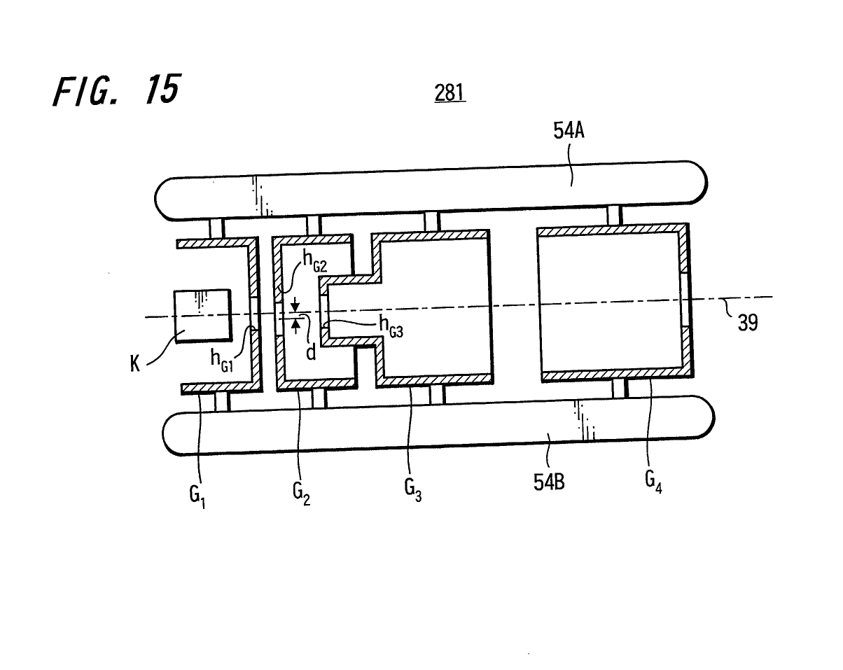

Further, the third grid G₃ and the fourth grid G₄ are positioned and then, a pair of bead glasses 54 (54A, 54B) are pushed against the first grid G₁ to the fourth grid G₄, thereby carrying out a beading processing. Thereafter, the cathode K is disposed in the first grid G₁ to obtain the final electron gun 281 shown in FIG. 15.

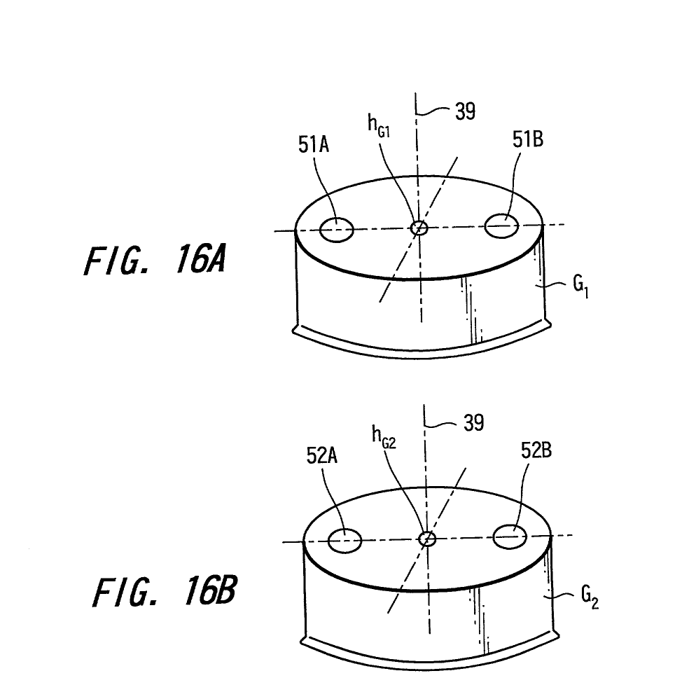

FIGS. 16 to 19 show a mode of a producing method of the above-described electron gun 282.

In this mode, first, as shown in FIGS. 16, the first grid G₁ (FIG. 16A) and the second grid G₂ (FIG. 16B) are prepared first. The first grid G₁ is formed with the electron beam through hole h_{G1} having a hole center which coincides with one reference position corresponding to a position on the center axis 39, and the first grid G₁ is also formed with a pair of index holes 51 (51A, 51B) other reference positions. The second grid G₂ is formed with the electron beam through hole h_{G2} having a hole center at a position corresponding to one reference position corresponding to a position on the center axis 39. The second grid G₂ is also formed with a pair of index holes 52 (52A, 52B) at other reference positions.

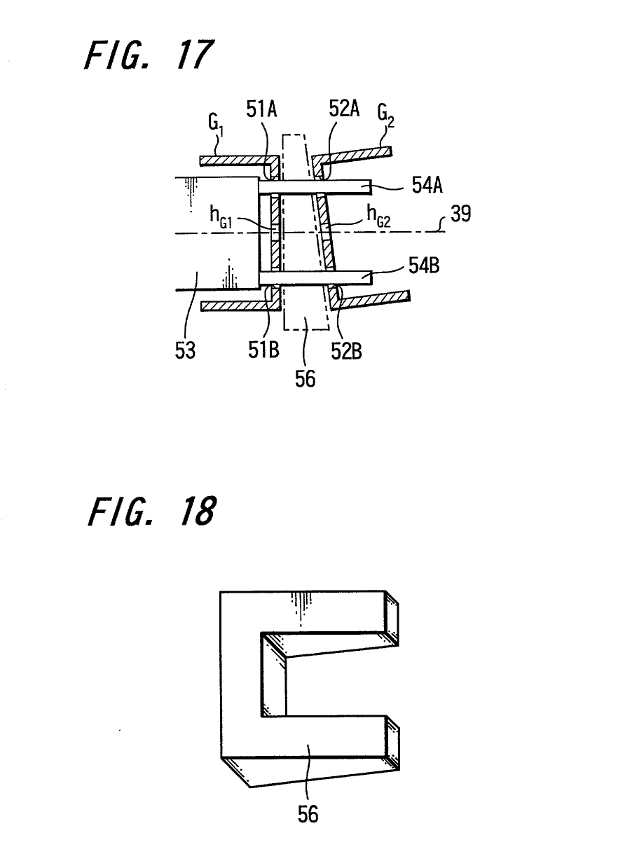

Then, as shown in FIG. 17, like the above mode, the first grid G₁ is positioned by inserting a pair of index pins 54 (54A, 54B) of a pad 53 into index holes 51 (51A, 51B) of the first grid G₁. Then, the second grid G₂ is positioned on the first grid G₁ by inserting index pins 54 (54A, 54B) into the pair of index holes 52 (52A, 52B) through a tapered spacer 56 (this is a spacer for defining the distance between the first grid G₁ and the second grid G₂ of course, and the spacer is formed into U-shape as viewed from its upper surface as shown in FIG. 18).

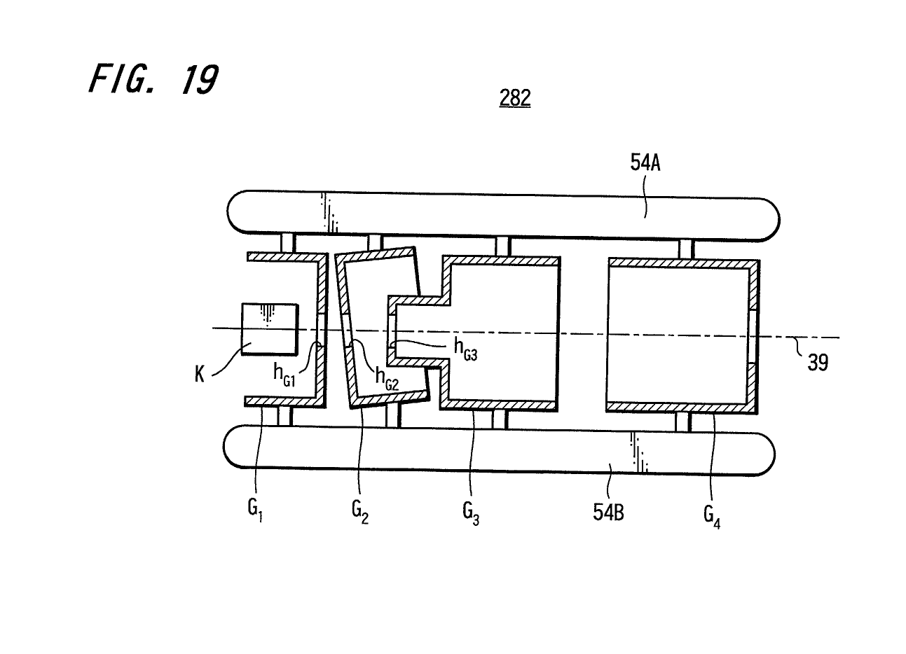

Further, the third grid G₃ and the fourth grid G4 are positioned and then, a pair of bead glasses 54 (54A, 54B) are pushed against the first grid G₁ to the fourth grid G₄, thereby carrying out a beading processing. Thereafter, the cathode K is disposed in the first grid G₁ to obtain the final electron gun 282 shown in FIG. 19.

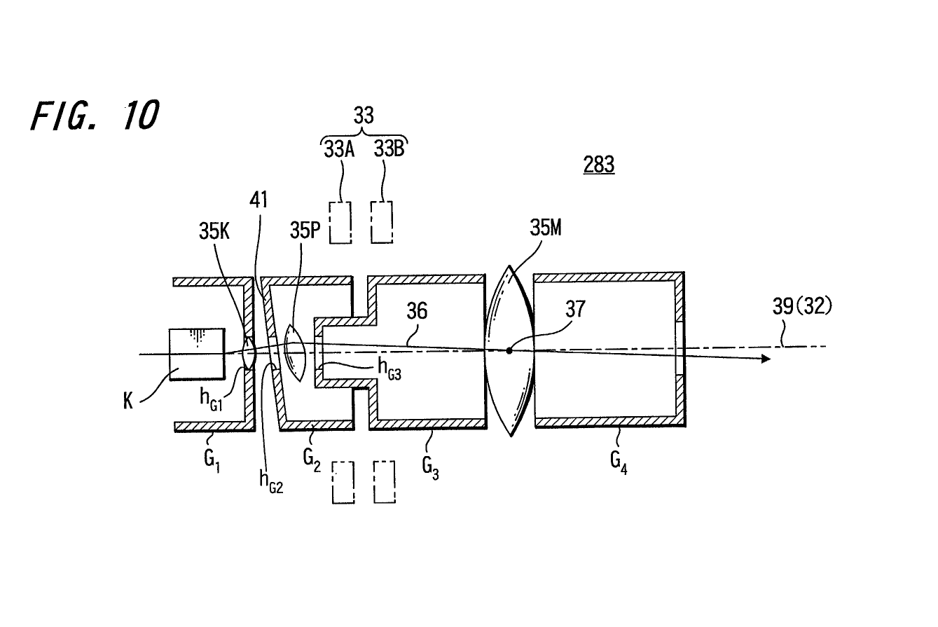

The producing method of the electron gun 283 in FIG. 10 is produced by the same producing method with the electron gun 282.

According to the producing method of the above-described electron guns 281, 282 and 283, when the method is used for the flat cathode-ray tube, it is possible to easily produce an electron gun capable of correcting effect of magnetic field caused by the centering magnet 33, i.e., an electron gun in which electron beam passing through the prefocus lens 35P passes the center of the main lens 35M to obtain excellent beam spot.

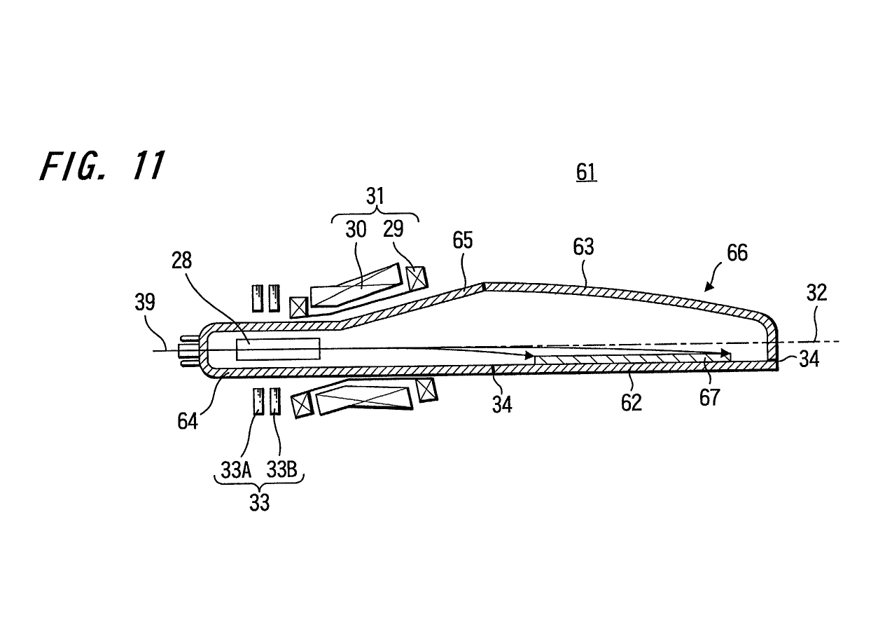

Although the screen panel 26 is inclined with respect to the tube axis 32 through a small angle in the flat cathode-ray tube 21 shown in FIG. 5, the screen panel may be in parallel to the tube axis as shown in FIG. 11.

A flat cathode-ray tube 61 according to the present mode shown in FIG. 11 includes a glass tube body 66. The glass tube body 66 comprises a screen panel 62 which is in parallel to the tube axis 32, a back panel 63, and a funnel 65 having a neck 64, and these constituent members of the glass tube body 66 are jointed to one another through frit glasses. A fluorescent surface 67 is formed on an inner surface of the screen panel 62. The electron gun 28 of the present invention is disposed in the neck 64 of the funnel 65 such that the center axis 39 coincides with the tube axis 32. In this flat cathode-ray tube 61, the screen panel 62 is disposed in parallel to the tube axis 32. Reference number 34 represents a frit junction. The glass body 66 is formed flatly such that the glass body 66 is laterally longer in the horizontal direction as a whole. The screen panel 62 is formed into a transparent flat-plate like shape and is disposed in parallel to the tube axis 32.

The above-described electron guns 281, 282, 283 and the like respectively shown in FIGS. 7, 9 and 10 can be used as the electron gun 28.

A deflection yoke 31 having a horizontal deflection coil 29 and a vertical deflection coil 30 is disposed outside of the glass body 66 at a location thereof from the neck 64 to the funnel 65 like the previous mode. A centering magnet 33 is disposed at an outside position of the neck 64 corresponding to the front portion of the deflection yoke 31.

In this flat cathode-ray tube 61, an electron beam 36 emitted from the electron gun 28 is deflected horizontally and vertically by the deflection yoke 31, and radiates onto the fluorescent surface 67 of the screen panel 62. A screen formed on the screen panel 62 can be seen from the side of the screen panel 62. The flat cathode-ray tube 61 in this case is a transparent type tube.

In this flat cathode-ray tube 61 of the present mode also, like the previous mode, an axis of the electron beam is separated by effect of the magnetic field of the centering magnet 33, but since the axis of the prefocus lens 35P of the electron gun 28 is separated, the axis-separation of the electron beam caused by the centering magnet 33 is offset, the electron beam passes through the center of the main lens 35M, the halation caused by the coma aberration is eliminated, and the resolution can be enhanced.

[Embodiment 1 of Flat Cathode-ray Tube]

Next, the flat cathode-ray tube of the above-described mode, i.e., the flat cathode-ray tube 21 having the electron gun 281 was actually produced, and a relation between the axis-separating amount of the electron beam caused by the magnetic field of the centering magnet 33 and the axis-separation of the prefocus lens in the electron gun was studied. A result thereof will be explained.

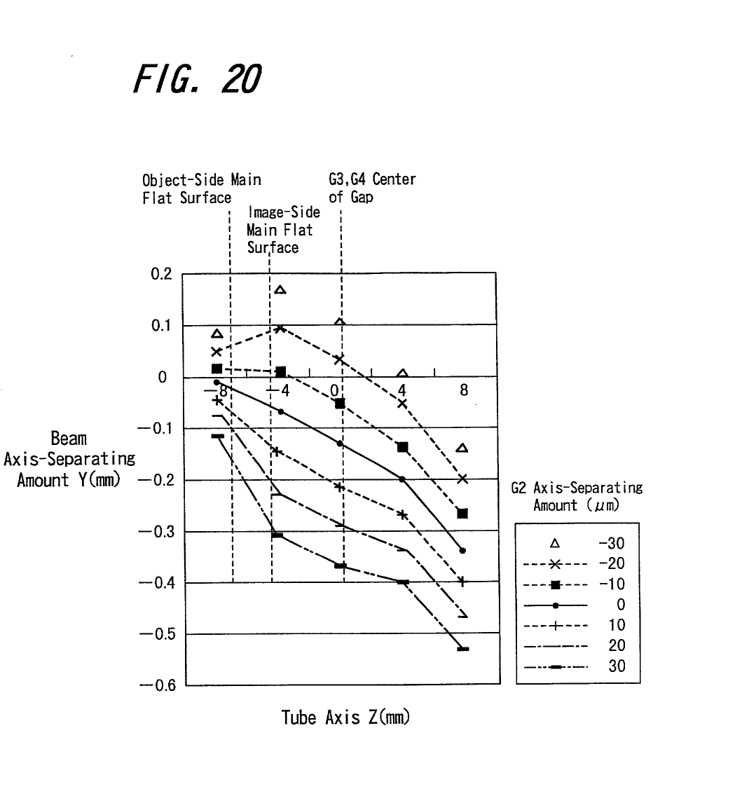

FIG. 20 is a graph showing a relation between the axis-separating amount (deviation amount) of the center of the second grid G₂ and thus, of the electron beam through hole h_{G2}, and the axis-separating amount of the electron beam. Here, a tube axis Z indicates a center of a gap between the third grid G₃ and the fourth grid G₄ forming the main lens 35M, an object-side main flat surface indicates a center of the second grid G₂, and an image-side main flat surface indicates a center of the third grid G₃.

According to this result, when a center of the electron beam through hole h_{G2} of the second grid G₂ is separated (deviated) as the axis-separating amount d in FIG. 7 from the tube axis 32 by an amount between −10 μm to −20 μm, e.g., about −15 μm, it is found that the axis-separating amount of the beam in the main lens 35M becomes minimum, and the axis-separation of the electron beam caused by the magnetic field of the centering magnet 33 is offset.

As one method for quantitatively showing an amount of coma aberration by the same electron gun, there is an SP (spot) moving amount. The SP moving amount is shown with an amount of a beam spot center core moving on the screen panel when the strength of the main focus lens of the electron gun is changed. When the SP moving amount is zero, the beam center passes through the center of the main focus lens and thus, the coma aberration is zero.

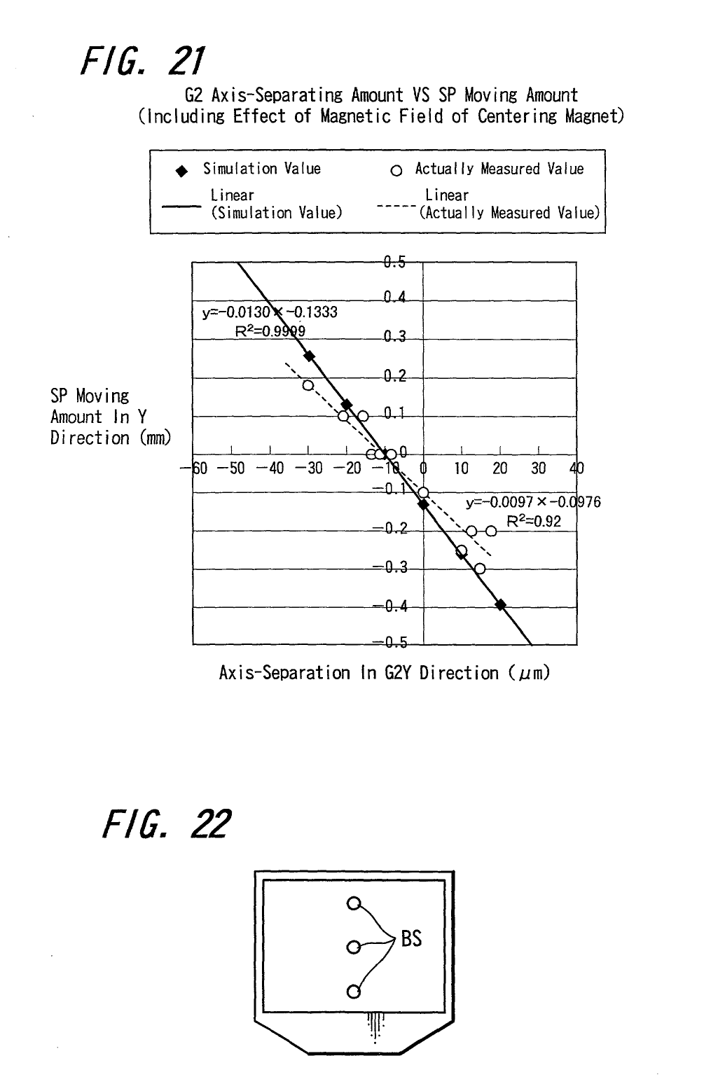

FIG. 21 is a graph showing a relation between the SP moving amount and the axis-separating amount (deviation amount) of the center of the electron beam through hole h_{G2} of the second grid G₂ using a simulation result and the actually measured data.

It can be found from FIG. 21 that when the axis of the second grid G₂ is separated, i.e., when the center of the electron beam through hole h_{G2} is deviated from the tube axis 32 by an amount of −15 μm (15 μm (therefore, from 0 to −30 μm, but 0 is not includes), the SP moving amount is reduced, and when the center is deviated by an amount of about from −10 μm to −20 μm, more preferably, from −10 μm to −15 μm, the SP moving amount becomes minimum. It was confirmed that in the beam spot when the center of the electron beam through hole h_{G2} of the second grid G₂ was deviated from the tube axis 32 by an amount from 0 to −15 μm (0 is not included), more preferably by an amount from −10 μm to −20 μm, and further preferably by an amount from −10 μm to −15 μm, beam spots BS having halation shown in FIG. 18 were obtained at a center, an upper end and a lower end of the screen panel. In a position where the center of the electron beam through hole h_{G2} of the second grid G₂ was separated from the tube axis 32 by an amount of −15 μm to an amount from −10 μm to −20 μm, the simulation result and the actually measured data coincided with each other substantially.

According to FIG. 21, when the axis-separating amount is in a range of −8 μm to −30 μm, the SP moving amount is stable in a range of 0.0 to 0.19. Whereas, when the axis-separating amount is in a range of +10 μm to +18 μm, the SP moving amount is dispersed in a range of −0.2 to −0.3, and variation of the SP moving amount is great. If the variation in the SP moving amount is great, when the focus is adjusted, the variation differs in every screen, which is inconvenient.

[Embodiment 2 of Flat Cathode-ray Tube]

The present inventors repeated an experiment of the flat cathode-ray tube 21 having the above-described electron gun 281 and studied the optimization of the axis-separating amount. A result thereof will be explained.

Table 1 shows a halation width of the beam spot, the SP moving amount, and horizontal (H) and vertical (V) limit resolution when the axis-separating amount (=d) of the electron beam through hole h_{G2} of the second grid G₂ is +15 μm and −15 μm, respectively.

TABLE 1

| | Limit resolution (TV) | | | | |
|---|---|---|---|---|---|
| Axis-separating | average (X) | | Halation | SP moving | |
| amount of beam | Horizontal | Vertical | width | amount (mm) | |
| hole of G₂ (μm) | (H) | (V) | (mm) | X | Y |
| +15 | ≧520 | ≧300 | 0.8 | 0 | −0.20 |
| −15 | ≧580 | ≧300 | 0 | 0 | 0.04 |

According to Table 1, it can be found that when the axis-separating amount is −15 μm, the halation width and the SP moving amount are smaller than those when the axis-separating amount is +15 μm, and the horizontal resolution is enhanced. When the axis-separating amount is −15 μm, it can be found that the halation width becomes “0”, and the variation in the SP moving amount is small and stable.

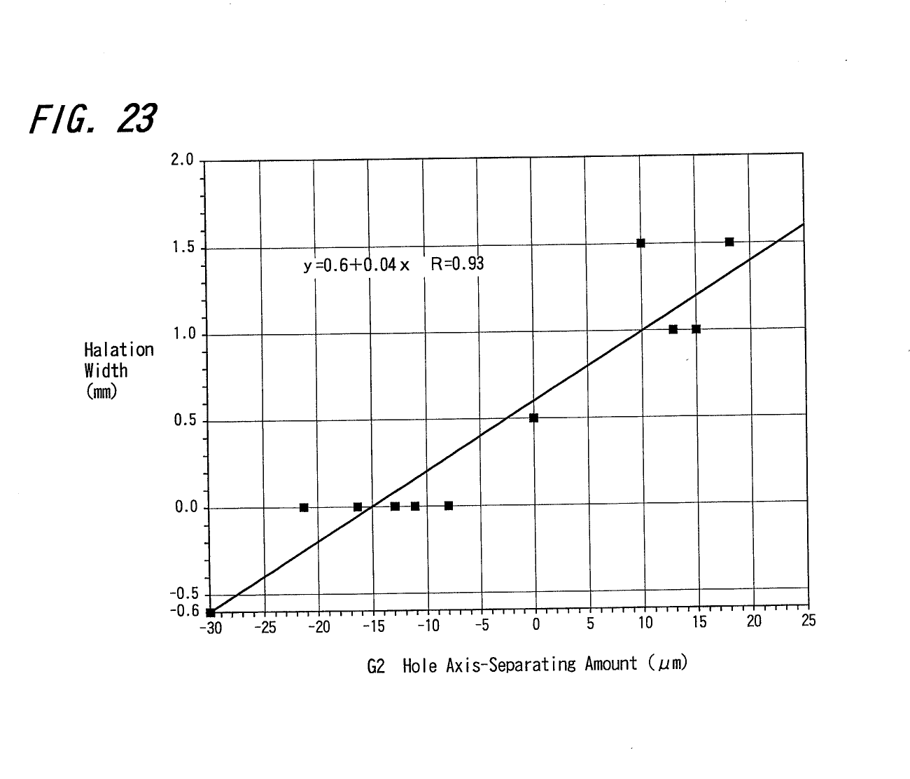

FIG. 23 is a graph showing a relation between the axis-separating amount of the electron beam through hole h_{G2} of the second grid G₂ and the halation width of the beam spot.

According to FIG. 23, it can be found that when the axis-separating amount is in a range of −8 μm to −21 μm, the halation width is concentrated on “0.0”, and when the axis-separating amount is −30 μm, the halation width is as small as −0.6 mm. On the other hand, when the axis-separating amount is in a range of 0 μm to +18 μm, it is found that the halation width is varied in a range of 0.5 to 1.5.

FIG. 24 is a graph showing a relation between the SP moving amount and the halation width of the beam spot when the axis-separating amount of the electron beam through hole h_{G2} of the second grid G₂ is in a range of −15 μm to +15 μm.

According to FIG. 24, it is found that when the axis-separating amount is −15 μm, the SP moving amount is as small as 0 to 0.1 and stable, and the halation width is 0.0 and stable. On the other hand, when the axis-separating amount is +15 μm, the SP moving amount is varied as great as −0.1 to −0.3, and the halation width is dispersed as great as 0.5 or more. The fact that the SP moving amount and the halation width are stable at 0.0 (or near 0.0) means that the electron beam passes through the center of the main lens 35M.

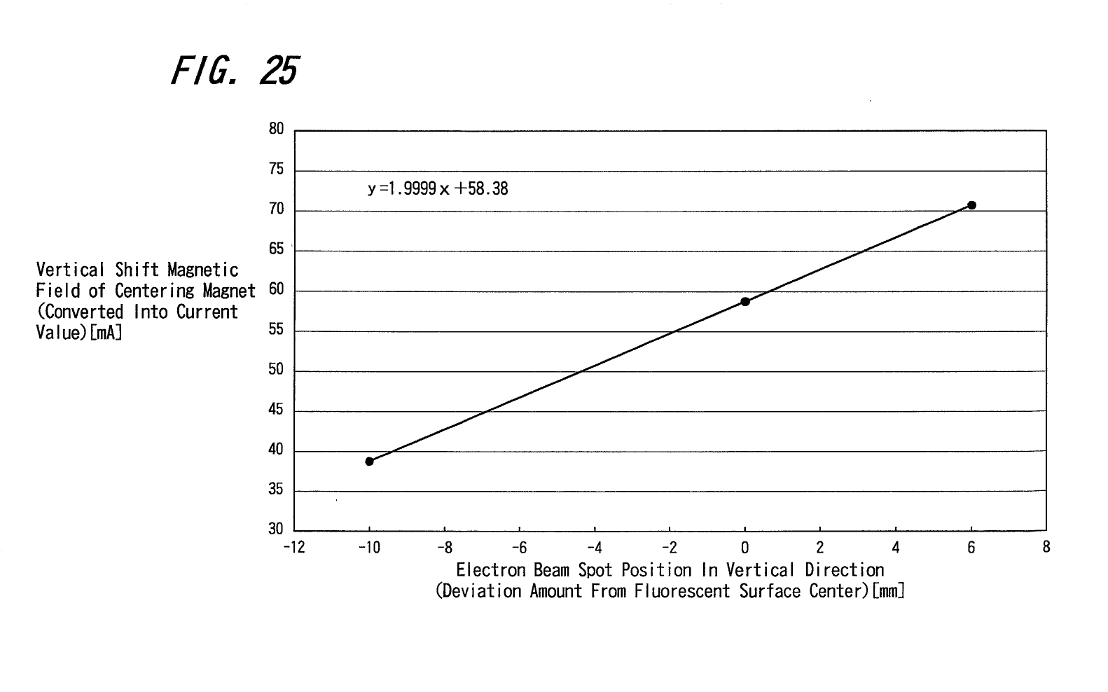

FIG. 25 is a graph showing a relation between a magnetic field of the centering magnet and a deviation amount of the electron beam spot position, i.e., a correlation between the magnetic field and the positional deviation amount of the beam spot. A lateral axis shows an electron beam spot position (so-called deviation amount from a center of the fluorescent surface: unit is mm) in a vertical direction of the screen, and a vertical axis shows a value (unit is mA) a vertical shift magnetic field of the centering magnet converted by a current value. From this graph, it can be found that the magnetic field of the centering magnet affects the positional deviation of the electron beam.

TABLE 2

| | Present invention | Prior art |
|---|---|---|
| Halation defect rate | 0% | 10 to 15% |

Table 2 shows a result of study of defective rate of halation of the beam spot in a conventional flat cathode-ray tube and the flat cathode-ray tube produced by the present invention. As shown in Table 2, in the flat cathode-ray tube of the present invention in which the axis of the electron beam through hole h_{G2} of the second grid G₂ was separated, the halation defective generation rate was 0%, and in the conventional flat cathode-ray tube, the defective generation rate was 10 to 15%. Incidentally, in the flat cathode-ray tube of the present invention, the number of defective tubes was zero (defective generation rate was 0%) among 423 cathode-ray tubes, and in the conventional flat cathode-ray tube, the number of defective tubes was 239 among 1885 cathode-ray tubes (defective generation rate was 12.7%). In the flat cathode-ray tube of the present invention, excellent result was obtained.

In the above examples, the present invention is applied to the bipotential type electron gun and to the flat cathode-ray tube having this electron gun, but the invention can also be applied to unipotential type electron gun and a flat cathode-ray tube having such an electron gun.

Although the axis-separation of the electron beam caused by effect of the magnetic field of the centering magnet 33 was corrected by the structure of the electron gun in the above examples, the present invention can also be applied to a case in which the electron beam is separated by effect of a magnetic field of another magnet disposed outside the neck or another location instead of the centering magnet 33.

### Effect of the Invention

According to the flat cathode-ray tube of the invention, by separating an axis of the prefocus lens in a direction in which the axis-separating amount of the electron beam caused by the magnetic field of the magnet becomes smaller, the electron beam whose axis is separated can be corrected, and even if the electron beam receives effect of the magnetic field of the magnet, it is possible to allow the electron beam to pass through the center of the main focus lens. As a result, halation caused by coma aberration can be eliminated, and the resolution can be enhanced.

When the flat cathode-ray tube is constituted such that the electron beam at the time of non-deflection is irradiated on a screen inoperative portion except a frit junction portion of a tube body, the frit junction portion is not deteriorated, the durability is excellent, and the reliability of the flat cathode-ray tube can further be enhanced.

According to the electron gun for the flat cathode-ray tube of the invention, an axis of the prefocus lens is separated in a direction in which the axis-separating amount of the electron beam caused by the magnetic field of the magnet disposed outside the neck becomes smaller. Therefore, it is possible to eliminate the effect of the axis-separation of the electron beam caused by the magnetic field from the magnet when the electron gun is incorporated into the flat cathode-ray tube. Thus, the resolution of the flat cathode-ray tube can be enhanced.

According to the electron gun for the flat cathode-ray tube of the invention, the center of the electron beam through hole of the second grid is separated, and the end surface having the electron beam of the second grid is inclined. Thus, the axis of the prefocus lens can be separated. Therefore, it is possible to eliminate the effect of the axis-separation of the electron beam caused by the magnetic field from the magnet, excellent beam spot can be obtained, and the resolution of the flat cathode-ray tube can be enhanced.

When the axis-separating amount of the electron beam through hole of the second grid is set to 0 to −30 μm (0 is not included), the moving amount of the electron beam spot and the halation width can be made as small as possible toward 0, and they can be stabilized.

According to the producing method of the electron gun for the flat cathode-ray tube of the invention, the axis-separation of the electron beam caused by the above-described electron gun, i.e., the magnetic field of the magnet can be corrected, and it is possible to easily produce the electron gun capable of obtaining excellent beam spot.

Having described preferred embodiments of the present invention with reference to the accompanying drawings, it is to be understood that the present invention is not limited to the above-mentioned embodiments and that various changes and modifications can be effected therein by one skilled in the art without departing from the spirit or scope of the present invention as defined in the appended claims.

What is claimed is:

1. A flat cathode-ray tube comprising an electron gun having a main focus lens whose center coincides with a tube axis, a deflection yoke, and a magnet disposed outside of a neck, characterized in that
a prefocus lens of the electron gun is separated from the tube axis.

2. The flat cathode-ray tube according to claim 1, characterized in that an electron beam at the time of non-deflection is irradiated on a screen inoperative portion except a frit junction portion of a tube body.

3. An electron gun for a flat cathode-ray tube comprising a cathode and a plurality of grids, characterized in that a prefocus lens is separated from a center axis of an electron gun in a direction in which an axis-separating amount of an electron beam caused by a magnetic field of a magnet which is disposed outside of a neck becomes smaller.

4. The electron gun for the flat cathode-ray tube according to claim 3, characterized in that centers of electron beam through holes of first and third grids of the plurality of grids coincide with a center axis of the electron gun, and a center of an electron beam through hole of second grid is separated from the center axis.

5. The electron gun for the flat cathode-ray tube according to claim 4, characterized in that an axis-separating amount of the center of the electron beam through hole of the second grid is 0 to −30 μm (0 is not included).

6. The electron gun for the flat cathode-ray tube according to claim 3, characterized in that centers of electron beam through holes of first and third grids of the plurality of grids coincide with a center axis of the electron gun, and an end surface having an electron beam the of a second grid is inclined with respect to the center axis.

7. A producing method of an electron gun for a flat cathode-ray tube, comprising the steps of:
preparing a first grid having an electron beam through hole formed at a reference position and having a positioning hole formed at another reference position, and preparing a second grip having an electron beam through hole separated from a reference position by a predetermined distance and having a positioning hole formed at another reference position, and
inserting positioning means in the positioning holes of the first and second grids for positioning the first and second grids in a state that a spacer is interposed between the first and second grids.

8. A producing method of an electron gun for a flat cathode-ray tube, comprising the steps of:
preparing a first grid having an electron beam through hole formed at a reference position and having a positioning hole formed at another reference position, and preparing a second grid having an electron beam through hole formed at a reference position and having a positioning hole formed at another reference position, and
inserting positioning means in the positioning holes of the first and second grids for positioning the first and second grids such that an end surface having an electron beam through hole of the second grid is inclined with respect to the first grid in a state that a tapered spacer is interposed between the first and second grids.
